(19) United States
(12) Patent Application Publication
(10) Pub. No.: US 2021/0302945 A1
(43) Pub. Date: Sep. 30, 2021

(54) INFORMATION PROCESSING APPARATUS, INFORMATION PROCESSING SYSTEM, AND NON-TRANSITORY COMPUTER READABLE MEDIUM STORING PROGRAM

(71) Applicant: FUJIFILM Business Innovation Corp., Tokyo (JP)

(72) Inventors: Kodai SUZUKI, Kanagawa (JP); Kei ARAKAWA, Kanagawa (JP); Ami KANZAKI, Kanagawa (JP)

(73) Assignee: FUJIFILM Business Innovation Corp., Tokyo (JP)

(21) Appl. No.: 16/940,399

(22) Filed: Jul. 28, 2020

(30) Foreign Application Priority Data
Mar. 25, 2020 (JP) 2020-054500

(51) Int. Cl. G05B 19/418; G06F 21/32; G06Q 50/04

(52) U.S. Cl. CPC G05B 19/41835; G05B 2219/31001; G06Q 50/04; G06F 21/32

(57) ABSTRACT

An information processing apparatus includes a processor configured to acquire process information indicating a plurality of processes of manufacturing a product by a worker using a device, acquire terminal information in which the worker in each of the plurality of processes is associated with a terminal carried by the worker, acquire at least one of a status indicating a state of any of a plurality of the devices or a status indicating a state of any of the plurality of processes, specify the worker who uses a device related to the acquired status by using the process information, and provide a notification of the acquired status to the terminal associated with the specified worker in the terminal information.

### CROSS-REFERENCE TO RELATED APPLICATIONS

This application is based on and claims priority under 35 USC 119 from Japanese Patent Application No. 2020-054500 filed Mar. 25, 2020.

### BACKGROUND

### (i) Technical Field

The present invention relates to an information processing apparatus, an information processing system, and a non-transitory computer readable medium storing a program.

### (ii) Related Art

In a manufacturing industry, there is a case where a plurality of processes, which are complicatedly related, are handled. For example, in a printing industry, there is a large amount of information to be managed, which include the number of required workers and working hours, resources and equipment such as printing machines or workbenches, and conditions for starting a work, for each of processes from sending a manuscript for printing to shipment, and a relationship between the information is also complicated. Therefore, a demand for a process management system that unitarily manages the processes increases every year. Further, the process management system is also required to dynamically optimize a work plan such as an order of the plurality of processes.

For example, JP2018-106542A discloses a technique for dynamically preparing the work plan by simulating an instructed work.

### SUMMARY

Aspects of non-limiting embodiments of the present disclosure relate to an information processing apparatus, an information processing system, and a non-transitory computer readable medium storing a program that, for pieces of information indicating a plurality of statuses generated in a plurality of processes of manufacturing products using a plurality of devices, suppress notifications unnecessary for the workers, compared to a case where all pieces of information are notified to all workers.

Aspects of certain non-limiting exemplary embodiments of the present disclosure address the above advantages and/or other advantages not described above. However, aspects of the non-limiting exemplary embodiments are not required to address the advantages described above, and aspects of the non-limiting exemplary embodiments of the present disclosure may not address advantages described above.

According to an aspect of the present disclosure, there is provided an information processing apparatus including a processor configured to acquire process information indicating a plurality of processes of manufacturing a product by a worker using a device, acquire terminal information in which the worker in each of the plurality of processes is associated with a terminal carried by the worker, acquire at least one of a status indicating a state of any of a plurality of the devices or a status indicating a state of any of the plurality of processes, specify the worker who uses a device related to the acquired status by using the process information, and provide a notification of the acquired status to the terminal associated with the specified worker in the terminal information.

### BRIEF DESCRIPTION OF THE DRAWINGS

Exemplary embodiment(s) of the present invention will be described in detail based on the following figures, wherein:

FIG. 1 is a diagram showing an example of an overall configuration of an information processing system 9;

FIG. 2 is a diagram showing an example of a configuration of an information processing apparatus 1;

FIG. 3 is a diagram showing an example of a worker DB 121;

FIG. 4 is a diagram showing an example of a terminal information DB 122;

FIG. 5 is a diagram showing an example of a device information DB 123;

FIG. 6 is a diagram showing an example of a process information DB 124;

FIG. 7 is a diagram showing an example of a process management table drawn based on the process information DB 124;

FIG. 8 is a diagram showing an example of a process information DB 124a;

FIG. 9 is a diagram showing an example of a configuration of a terminal 2;

FIG. 10 is a diagram showing an example of a functional configuration of the information processing apparatus 1;

FIG. 11 is a flowchart showing an example of a flow of an operation of authentication processing;

FIG. 12 is a flowchart showing an example of a flow of an operation of notification processing in a normal case;

FIG. 13 is a flowchart showing an example of the flow of the operation of the notification processing in a case where a device is abnormal;

FIG. 14 is a flowchart showing an example of the flow of the operation of the notification processing in a case where an unscheduled work is detected;

FIGS. 15A to 15C are diagrams showing examples of transition of a schedule table 1244 in the case where the unscheduled work is detected; and

FIG. 16 is a diagram showing an example of a process management table changed by adding a process.

### DETAILED DESCRIPTION

### Exemplary Embodiment

Configuration of Information Processing System

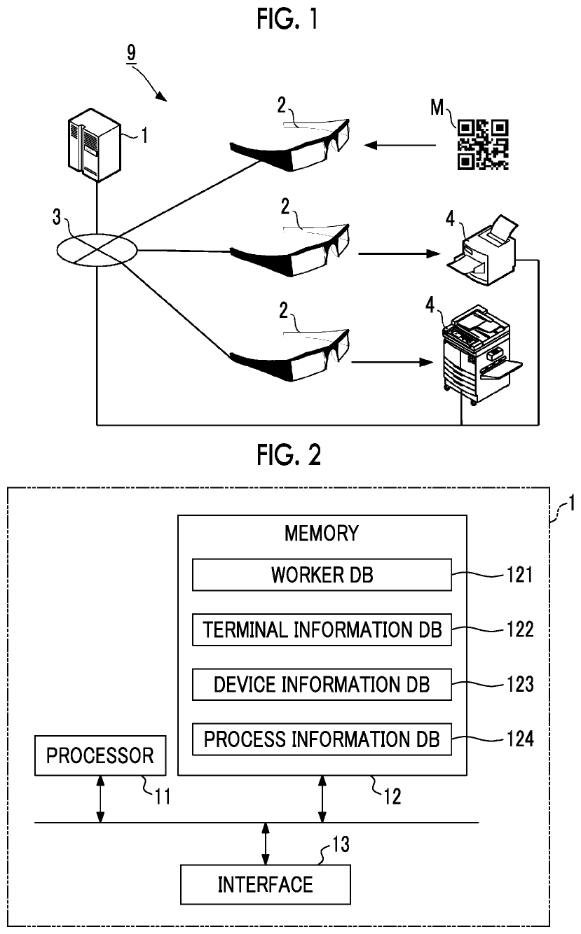

FIG. 1 is a diagram showing an example of an overall configuration of an information processing system 9. The information processing system 9 shown in FIG. 1 is an information processing system that manages a plurality of processes of manufacturing a product, workers who perform work in the processes, and devices used for the workers. As shown in FIG. 1, the information processing system 9 includes an information processing apparatus 1, a terminal 2, a communication line 3, and a device 4.

The terminal 2 is a terminal device which is managed by the information processing system 9 and is carried by each worker in a case where work is performed. For example, the terminal 2 shown in FIG. 1 is a glasses-type wearable terminal device. In a case where the worker carries the terminal 2 by wearing the terminal 2 on a head, a transmission-type display is arranged in front of eyes of the worker. The worker views a video obtained by superimposing light, which penetrates through the display and reaches from actual surroundings and environments, on virtual images generated by the display. As a result, the worker experiences so-called Mixed Reality (MR) or Augmented Reality (AR). The terminal 2 is an example of a wearable terminal worn on the head of the worker.

The information processing apparatus 1 is, for example, a computer, and is an information processing apparatus that manages a plurality of processes of manufacturing a product, a plurality of workers who perform work in the processes, and a plurality of devices respectively used by the plurality of workers. The information processing apparatus 1 is connected to the terminal 2 via the communication line 3. In addition, the information processing apparatus 1 is connected to any of the devices 4 which will be described later and which can be connected to the communication line 3.

The communication line 3 is a communication line that connects the information processing apparatus 1 to the terminal 2 to be communicable with each other. The communication line 3 may be, for example, a Local Area Network (LAN), a Wide Area Network (WAN), the Internet, or a combination of the LAN, the WAN, and the Internet. In addition, the communication line 3 may include a public Switched Communication Network (PSTN), an Integrated Services Digital Network (ISDN), or the like.

The device 4 includes various types of machines, devices, tools, instruments, and the like used in a case where the worker performs the work in the above-described processes. In addition to the above devices, the device 4 includes a room, a place, a workspace obtained through division by a partition, and the like. In short, in the information processing system 9, the device 4 includes various articles used by the worker.

For example, in a case where the product is a printed matter such as a book or a magazine, the device 4 includes a printing machine, a processing machine, or the like. Further, the device 4 includes an inspection table that is not an electric machine, a transport vehicle that is not connected to the communication line 3 to be communicable, or the like. In addition, the device 4 may include, for example, a welding machine, a tool, a jig, a crane, an analysis device, or the like.

The device 4 shown in FIG. 1 is, for example, a printing machine or a processing machine. The printing machine is an image forming device that forms and fixes a designated image on a medium such as paper. The processing machine is, for example, a series of devices that bend printed paper at a determined position, cut the paper into a determined size, and bundle the paper in a determined order and number of sheets for bookbinding. The device 4 which is the printing machine or the processing machine shown in FIG. 1 is connected to the communication line 3, and is connected to the information processing apparatus 1 to be communicable via the communication line 3.

In addition, the information processing system 9 shown in FIG. 1 includes the device 4 (not shown), such as an inspection table, that is not connected to the communication line 3. Since the inspection table is not connected to the communication line 3, the information processing apparatus 1 does not acquire information from the inspection table. However, for example, an encoded image M shown in FIG. 1 is attached to the inspection table. The encoded image M is, for example, a two-dimensional code and is an image obtained by encoding identification information for identifying the inspection table.

The terminal 2 shown in FIG. 1 includes an imaging unit 26 (which will be described later), such as a digital camera, including an imaging element such as a Complementary Metal Oxide Semiconductor (CMOS) image sensor or a Charge Coupled Device (CCD) image sensor. Therefore, in a case where the above-described encoded image M is imaged and analyzed, the inspection table which is the device 4 located in front of the eyes of the worker is identified.

Note that, the number of components each included in the information processing system 9 is not limited to the number shown in FIG. 1.

Configuration of Information Processing Apparatus

FIG. 2 is a diagram showing an example of a configuration of the information processing apparatus 1. The information processing apparatus 1 shown in FIG. 2 includes a processor 11, a memory 12, and an interface 13. The components are connected by, for example, a bus to be communicable with each other.

The processor 11 controls each unit of the information processing apparatus 1 by reading and executing a computer program stored in the memory 12 (hereinafter, simply referred to as a program). The processor 11 is, for example, a Central Processing Unit (CPU).

The interface 13 is a communication circuit that connects the information processing apparatus 1 to the plurality of terminals 2 to be communicable via the communication line 3 in a wired or wireless manner. In addition, the interface 13 is connected to any of the devices 4 having a communication function via the communication line 3 in a wired or wireless manner.

The memory 12 is a storage unit that stores an operating system, various programs, data, and the like which are read by the processor 11. The memory 12 includes a Random Access Memory (RAM) and a Read Only Memory (ROM). Note that, the memory 12 may include a solid state drive, a hard disk drive, or the like. In addition, the memory 12 stores a worker DB 121, a terminal information DB 122, a device information DB 123, and a process information DB 124.

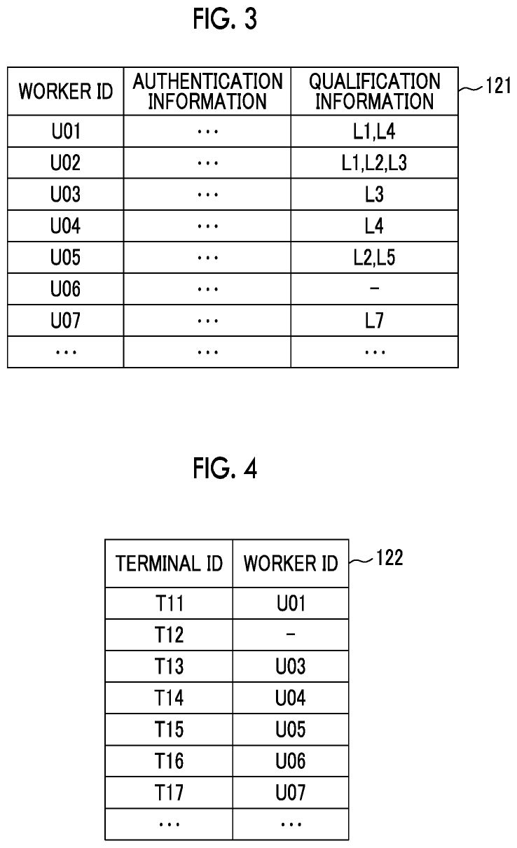

FIG. 3 is a diagram showing an example of the worker DB 121. The worker DB 121 is a database that stores information on the workers who perform the work in the processes of manufacturing the product.

In the worker DB 121 shown in FIG. 3, a worker ID is identification information for identifying each of the plurality of workers. Authentication information is information for authentication that certifies the worker. The information processing apparatus 1 checks, that is, authenticates, the worker who requests authentication under the worker ID by using a set of the worker ID and the authentication information in the worker DB 121. For the authentication, for example, any of knowledge authentication, owned property authentication, and biometric authentication may be used. Therefore, the authentication information is, for example, a password, fingerprint information, iris information, face information, or the like.

Qualification information is information on a qualification possessed by the worker identified by the worker ID. The qualification is a rank, a position, or the like for being engaged in the work in the above-described processes, and includes, for example, a national qualification, a qualification or a position, which is defined in a company. In the worker DB 121 shown in FIG. 3, for example, a worker indicated by a worker ID “U01” has qualifications “L1” and “L4”, and a worker indicated by a worker ID “U04” has the qualification “L4”.

FIG. 4 is a diagram showing an example of the terminal information DB 122. The terminal information DB 122 stores a plurality of terminals 2 prepared in a factory in which the product is manufactured, the workers who respectively carry the plurality of terminals 2 in association with each other using a set of the identification information (hereinafter, also referred to as terminal information).

For example, in a case where the plurality of workers go to work in the factory, the workers select and carry any of the plurality of terminals 2, receive authentication processing, and start the work. In this case, there is a possibility that the workers and the terminals 2 carried by the workers may differ from day to day. Whenever the workers select and carry the terminals 2, the terminal information DB 122 associates the workers with the terminals 2 carried by the workers using the identification information.

In the terminal information DB 122 shown in FIG. 4, for example, the worker indicated by the worker ID “U01” carries the terminal 2 indicated by a terminal ID “T11”. Note that, “−” indicates absence. That is, in the terminal information DB 122, the worker carrying a terminal ID “T12” is absent.

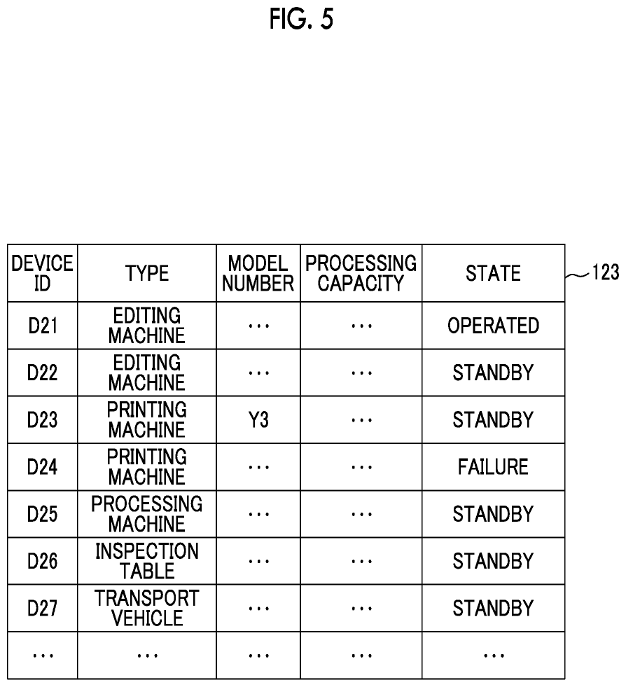

FIG. 5 is a diagram showing an example of the device information DB 123. The device information DB 123 is a database that stores information on each of the plurality of devices 4 possessed in the factory or the like in which the information processing system 9 is used.

In the device information DB 123 shown in FIG. 5, a “device ID” field is a field in which identification information for identifying the device 4 is stored. A “type” field is a field in which information indicating a type of the device 4 identified by the corresponding device ID is stored. A “model number” field is a field in which information indicating a model number of the above-described device 4 is stored. A “processing capacity” field is a field in which information indicating a processing capacity of the above-described device 4 is stored. A “state” field is a field in which information indicating a current state of the above-described device 4 is stored.

In the device information DB 123 shown in FIG. 5, for example, both the devices 4 indicated by device IDs “D21” and ID “D22” are editing machines. Here, the editing machine is a computer or the like installed with software or the like for editing print data. Further, the editing machine indicated by the device ID “D21” is operated, and the editing machine indicated by the device ID “D22” is on standby.

In addition, in the device information DB 123, for example, devices 4 indicated by device IDs “D23” and “D24” are printing machines. In the example, two printing machines exist in the factory, and the printing machine identified by the device ID “D23” is a printing machine of a model number “Y3”. Further, according to the device information DB 123, the printing machine identified by the device ID “D23” is on standby, and the printing machine identified by the device ID “D24” fails.

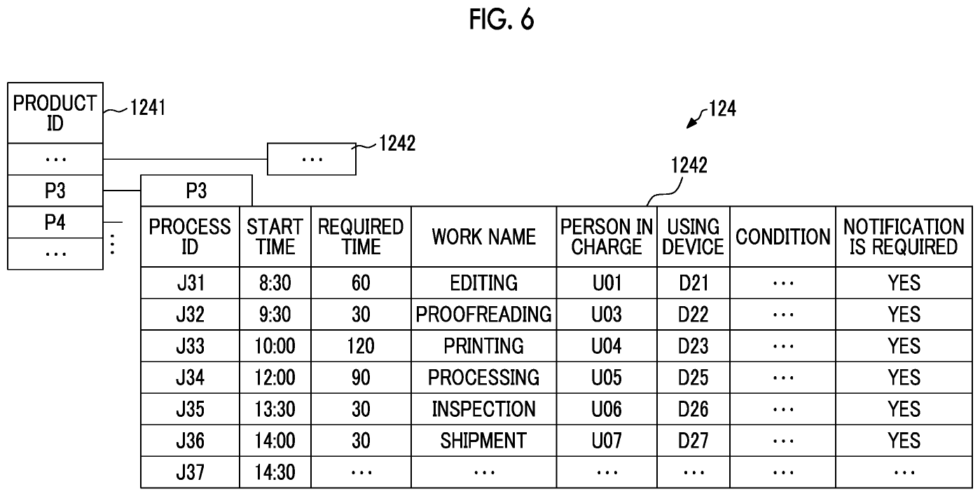

FIG. 6 is a diagram showing an example of the process information DB 124. The process information DB 124 is a database that stores, for each product manufactured in the factory or the like, information on the plurality of processes for manufacturing the product. The process information DB 124 shown in FIG. 6 includes a product list 1241 and a process table 1242.

The product list 1241 is a list of listing product IDs that are identification information for identifying products. The process table 1242 is a table provided in association with each of the product IDs listed in the product list 1241 one by one, and is a table that stores process information indicating each of the plurality of processes for manufacturing the product identified by the product ID.

In the process table 1242, a “process ID” field is a field, in which identification information for identifying the process, is stored. A “start time” field is a field, in which information indicating a time at which the process identified by the corresponding process ID starts, is stored. A “required time” field is a field, in which a time required until the above-described process ends, is stored. A “work name” field is a field, in which a name of the work performed in the process, is stored. A “person in charge” field is a field, in which a worker ID indicating a worker who is in charge of the above-described work, is stored. A “using device” field is a field, in which the device ID indicating the device 4 used by the worker in the above-described work, is stored. A “condition” field is a field, in which a condition necessary for executing the above-described process, is stored.

For example, the “condition” field may be described with the type and the model number of the device 4 necessary to execute the corresponding process, the number of devices 4, the number of workers, the qualifications possessed by the workers, and the like. In addition, the “condition” field may be described with identification information of another process which should be completed to execute the corresponding process.

For example, in a case where completion of the process indicated by the process ID “J31” is described in the “condition” field corresponding to the process ID “J32”, the process indicated by the process ID “J32” cannot be executed until the process indicated by the process ID “J31” is completed. On the other hand, in a case where completion of the process indicated by the process ID “J31” is described and completion of the process indicated by the process ID “J32” is not described in the “condition” field corresponding to the process ID “J33”, the process indicated by the process ID “J33” cannot be executed until the process indicated by the process ID “J31” is completed but can be executed even though the process indicated by the process ID “J32” is not completed. That is, in this case, in a case where the process indicated by the process ID “J31” is completed, any of the processes indicated by the process ID “J32” and the process ID “J33” may be executed first or may be executed in parallel.

A “notification is required” field is a field stored with information indicating whether or not information (hereinafter, referred to as a status) on a state of the process or a state of the device 4 used in the process is necessary to be notified to the worker identified by the worker ID written in the field of the corresponding person in charge.

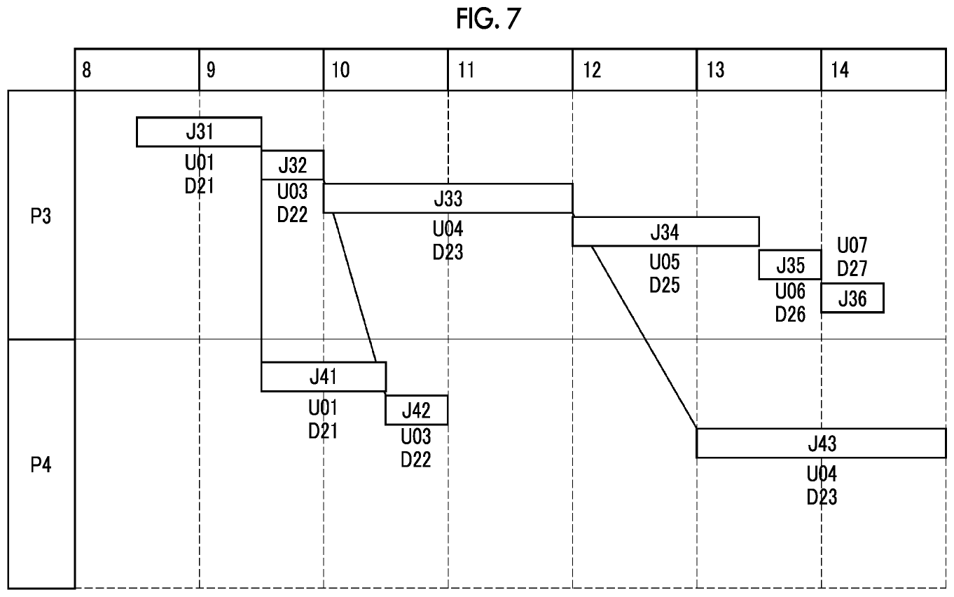

FIG. 7 is a diagram showing an example of a process management table drawn based on the process information DB 124. The process management table shown in FIG. 7 is a chart which is so-called Gantt chart or the like. The chart shown in FIG. 7 shows a flow of time in a horizontal direction which faces the right from the left, and shows a process which is performed to manufacture a product at each time. The chart describes, for each process, the identification information of the worker who works in the process and the identification information of the device 4 used by the worker.

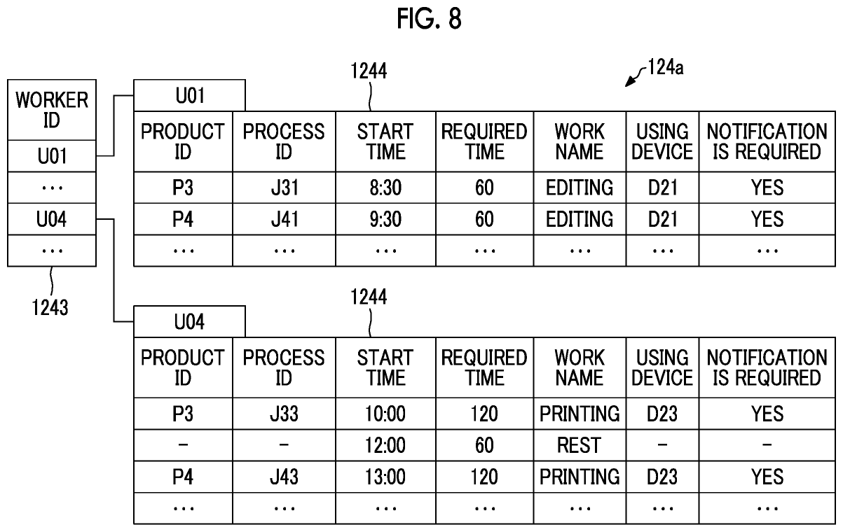

FIG. 8 is a diagram showing an example of a process information DB 124a. The process information DB 124a shown in FIG. 8 is a database obtained through conversion performed on the above-described process information DB 124, and is obtained through conversion performed on a structure of data by extracting process information for each worker from the process information DB 124 using, for example, a query. The process information DB 124a includes a worker list 1243 and a schedule table 1244.

The worker list 1243 is a list of listing the worker IDs which each is identification information for identifying the worker. The schedule table 1244 is a table that is provided to be associated with each of the worker IDs listed in the worker list 1243, and is a table that stores schedule information indicating each schedule of any of the plurality of processes in which the worker identified by the worker ID performs the work. Each of the fields in the schedule table 1244 is a field in which content common to the above-described process table 1242 and the product list 1241 is stored.

The process information DB 124a shown in FIG. 8 is extracted from the process information DB 124 shown in FIG. 7, obtained through conversion on a structure, and stores the common content. Therefore, the process information stored in the process information DB 124 shown in FIG. 7 is an example of the process information including the schedule information indicating the schedule of any of the plurality of processes in which the worker performs the work.

Configuration of Terminal

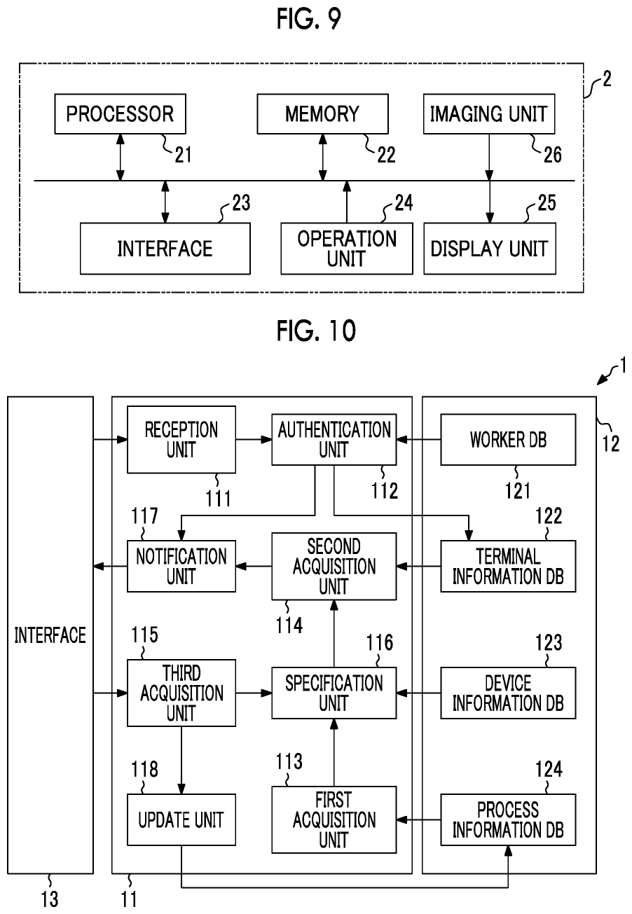

FIG. 9 is a diagram showing an example of a configuration of the terminal 2. The terminal 2 is a terminal machine carried by the worker, and includes, for example, a smartphone, a tablet PC, a wearable terminal, or the like. The terminal 2 shown in FIG. 9 includes a processor 21, a memory 22, an interface 23, an operation unit 24, a display unit 25, and the imaging unit 26. The components are connected by, for example, a bus to be communicable with each other.

The processor 21 controls each unit of the terminal 2 by reading and executing a program stored in the memory 22. The processor 21 is, for example, a CPU.

The memory 22 is a storage unit that stores an operating system read by the processor 21, various programs, data, and the like. The memory 22 includes a RAM and a ROM. Note that, the memory 22 may include a solid state drive, a hard disk drive, or the like.

The interface 23 is a communication circuit that connects the terminal 2 to the communication line 3 in wired or wireless manner. In addition, the interface 23 may have a function of connecting to another device which is in a near field using a method in conformity of a Near Field Communication (NFC) standard, for example, ISO/IEC18092 (NFCIP-1), ISO/IEC14443, ISO/IEC15693, or IEEE802.15.

The operation unit 24 includes operators, such as operation buttons, for giving various instructions, receives an operation, and sends a signal according to the content of the operation to the processor 21.

In a case where the terminal 2 is, for example, a smartphone, the operation unit 24 may include a keyboard and a touch panel. In addition, in a case where the terminal 2 is a mobile computer such as a tablet PC, the operation unit 24 may include a mouse that is a pointing device.

In addition, in a case where the terminal 2 is, for example, the glasses-type wearable terminal device shown in FIG. 1, the operation unit 24 includes an acceleration sensor that measures acceleration in triaxial directions, a vibration gyro sensor which obtains an angular velocity from. Coriolis force applied to an element such as a piezoelectric vibrator, and the like, and measures a posture of the terminal 2, and may specify a gesture intended for the operation from the movement of the head of the worker wearing the terminal 2 based on the acceleration and the angular velocity measured by the sensors.

The display unit 25 includes a display screen such as a liquid crystal display, and displays an image under the control of the processor 21. In a case where the terminal 2 is, for example, a smartphone or a mobile computer, a transparent touch panel of the operation unit 24 may be arranged on the display screen in an overlapping manner.

In addition, in a case where the terminal 2 is, for example, the glasses-type wearable terminal device shown in FIG. 1, the display unit 25 may be a transmission-type display arranged in front of eyes of the worker who wears the terminal 2 as described above. A projection method of the transmission-type display may be a method of projecting a video on abeam splitter, such as a half mirror, arranged in front of the eyes of the worker or may be a method of projecting a video by directly irradiating a laser beam or the like toward retinas.

In addition, the display unit 25 may include an output mechanism, such as a speaker, that outputs sound under the control of the processor 21 instead of or in addition to the display screen. In short, the display unit 25 may have a function of displaying an image and presenting information to the worker who wears the terminal 2.

The imaging unit 26 is a digital camera including the above-described imaging element. In a case where the terminal 2 is, for example, the glasses-type wearable terminal device shown in FIG. 1, the imaging unit 26 images a direction of a line of sight of the worker who wears the terminal 2 and supplies a video signal indicating the imaged video to the processor 21. In addition, the imaging unit 26 may image eyeballs of the worker and the retinas within the eyeballs in addition to the above-described direction of the line of sight. The video obtained by imaging the eyeballs may be handled as data indicating movement of the eyes of the worker. In addition, the video obtained by imaging the retinas may be used for authentication as biometric information of the worker.

The terminal 2 shown in FIG. 9 detects the device 4 by imaging, analyzing, and identifying the encoded image M attached to the device 4 existing around the terminal 2 by the imaging unit 26. In a case where a fact that the terminal 2 detects the device 4 is notified to the information processing apparatus 1, the information processing apparatus 1 understands that the worker carrying the terminal 2 exists in a vicinity of the detected device 4, that is, at least a range which can be managed by the imaging unit 26.

Note that, a positional relationship between the terminal 2 and the device 4 may be detected by another method. For example, in a case where both the above-described interface 23 of the terminal 2 and the device 4 have a near field communication function, the device 4 may establish the near field communication with the terminal 2 and may notify the establishment to the information processing apparatus 1 via the communication line 3. In addition, in a case where the device 4 is provided with a function of imaging the terminal 2, the device 4 may image the encoded image M attached to the terminal 2 to identify the terminal 2, and may notify a result of identification to the information processing apparatus 1.

Functional Configuration of Information Processing Apparatus

FIG. 10 is a diagram showing an example of a functional configuration of the information processing apparatus 1. The processor 11 of the information processing apparatus 1 functions as a reception unit 111, an authentication unit 112, a first acquisition unit 113, a second acquisition unit 114, a third acquisition unit 115, a specification unit 116, a notification unit 117, and an update unit 118 by executing the program stored in the memory 12.

The reception unit 111 receives, for example, the worker ID indicating the worker, the authentication information of the worker, and the terminal ID indicating the terminal 2 from the terminal 2 via the communication line 3 and the interface 13. In this case, the terminal 2 images, for example, a one-dimensional code or a two-dimensional code printed on an ID card, an employee ID card, or the like owned by the worker by using the imaging unit 26, and extracts the worker ID included in the code.

In addition, the terminal 2 generates the authentication information of the worker from one or more images imaged by the imaging unit 26. The one or more images that are basis of the authentication information are, for example, images obtained by imaging the biometric information such as the retinas, irises, and fingerprints of the worker. In addition, the one or more images may be a moving image obtained by imaging movement of a hand, a finger, or the like used for expressing the password by the worker.

Further, the terminal 2 transmits the terminal ID which indicates the terminal 2 and is stored in the ROM or the like included in the memory 22 in advance, to the information processing apparatus 1, together with the extracted worker ID and the generated authentication information, via the communication line 3. The reception unit 111 receives the transmitted data and delivers the data to the authentication unit 112. Note that, the worker ID, the authentication information, and the terminal ID, which are described above, may be acquired by a machine other than the terminal 2 and may be transmitted to the information processing apparatus 1. For example, the information processing system 9 includes a reception terminal device (not shown) connected to the communication line 3, a gate monitoring device, and the like, and may cause the devices to acquire the worker ID, the authentication information, and the terminal ID, instead of the above-described terminal 2.

The authentication unit 112 acquires the worker ID, the authentication information, and the terminal ID received by the reception unit 111 from the terminal 2, and determines whether or not a set of the worker ID and the authentication information matches a set stored in the worker DB 121. In a case where the sets match each other, the authentication unit 112 determines that a person who sends the authentication information is the worker identified by the worker ID, and stores the received set of the worker ID and terminal ID in the terminal information DB 122. In addition, in this case, the authentication unit 112 instructs the notification unit 117 to notify that the authentication is successful to the above-described terminal 2 of the worker. On the other hand, in a case where the sets do not match, the authentication unit 112 instructs the notification unit 117 to notify that the authentication fails.

In a case where the authentication performed by the authentication unit 112 is successful, the first acquisition unit 113 acquires the process information indicating the plurality of processes, in which the authenticated worker performs work for manufacturing the product, from the process information DB 124 stored in the memory 12. That is, the processor 11 that functions as the first acquisition unit 113 is an example of a processor that acquires the process information indicating the plurality of processes in which the worker manufactures the product using the device.

The second acquisition unit 114 acquires the terminal information that is a set, which is acquired by associating the worker ID indicating the worker with the terminal ID indicating the terminal carried by the worker, from the terminal information DB 122 stored in the memory 12. That is, the processor 11 that functions as the second acquisition unit 114 is an example of a processor that acquires the terminal information in which the worker is associated with the terminal carried by the worker in each of the plurality of processes.

The third acquisition unit 115 acquires information indicating a state of any of the plurality of devices 4 included in the information processing system 9 or any of the plurality of processes of manufacturing the product, that is, “status”. That is, the processor 11 that functions as the third acquisition unit 115 is an example of a processor that acquires at least one of a status indicating the state of any of the plurality of devices or a status indicating the state of any of the plurality of processes.

For example, the status of the device 4 is detected by the device 4 itself or the terminal 2 that images the device 4, and is notified to the information processing apparatus 1. In a case where the device 4 detects the status of the device 4 and is connected to the communication line 3, the third acquisition unit 115 may acquire the status of the device 4, which is detected by the device 4, via the communication line 3. In this case, the processor 11 that functions as the third acquisition unit 115 is an example of a processor that, in a case where the device is connected to the information processing apparatus 1 via a network, acquires the status of the device via the network.

In a case where the third acquisition unit 115 acquires the status of the device 4 or the process, the specification unit 116 specifies the device 4 related to the status. Here, in a case where the acquired status is the status of the device 4, the device 4 related to the status is the device 4 whose state is indicated by the acquired status. In addition, in a case where the acquired status is the status of the process, the device 4 related to the status is the device 4 used by the worker in a process whose state is indicated by the acquired status. Further, the specification unit 116 specifies the worker who uses the specified device 4 based on the process information acquired from the process information DB 124. That is, the processor 11 that functions as the specification unit 116 is an example of a processor that specifies the worker who uses the device related to the acquired status by using the process information.

The specification unit 116 supplies the worker ID indicating the specified worker to the second acquisition unit 114. The second acquisition unit 114 specifies the terminal 2 carried by the worker identified by the worker ID based on the terminal information acquired from the terminal information DB 122, and supplies the terminal ID which is the identification information to the notification unit 117.

The notification unit 117 notifies the status acquired by the third acquisition unit 115 to the terminal 2 identified by the terminal ID supplied from the second acquisition unit 114. That is, the processor 11 that functions as the notification unit 117 is an example of a processor that provides a notification of the acquired status to the terminal associated with the specified worker in the terminal information. Note that, as described above, the notification unit 117 shown in FIG. 10 also provides a notification according to an instruction from the authentication unit 112.

The update unit 118 monitors a change in the status of the device 4 or the process, which is acquired by the third acquisition unit 115, and updates the process information DB 124 according to the change. For example, in a case where the third acquisition unit 115 acquires the status of the device 4 via the interface 13, the update unit 118 searches the process information DB 124 for the process table 1242 including the process in which the device 4 is used.

Further, the update unit 118 refers to the “condition” field corresponding to the above-described process in the found process table 1242 to determine whether or not the device 4 in the acquired status satisfies the condition for executing the process. In a case where the device 4 does not satisfy the condition, the update unit 118 performs an update of stopping the above-described process, generating a process for compensating for the stopped process according to a predetermined procedure, and adding the process to the process information DB 124.

For example, in a case where another device 4 that satisfies the condition is available at a current point of time, the update unit 118 adds a new process of replacing a device 4 that does not satisfy the condition with the available device 4 to the process information DB 124. In addition, in a case where, even though another device 4 that satisfies the condition at the current point of time does not exist, the device 4 is available in the future, the update unit 118 adds a new process which is started from a point of time at which the device 4 is available to the process information DB 124, and adds a process of causing the worker to stand by until the point of time or to be engaged with another work. That is, the processor 11 that functions as the update unit 118 is an example of a processor that updates process information indicating a process, in which the device is used, according to the change in the device related to the acquired status.

Operation of Information Processing Apparatus

The processor 11 of the information processing apparatus 1 performs notification processing of providing a notification of information to the worker via the terminal which is carried, in addition to the authentication processing. The notification processing includes, for example, notification processing in a normal case, notification processing in a case where the device is abnormal, and notification processing in a case where an unscheduled work is detected. The processing is executed in parallel in the processor 11.

Operation of Authentication Processing

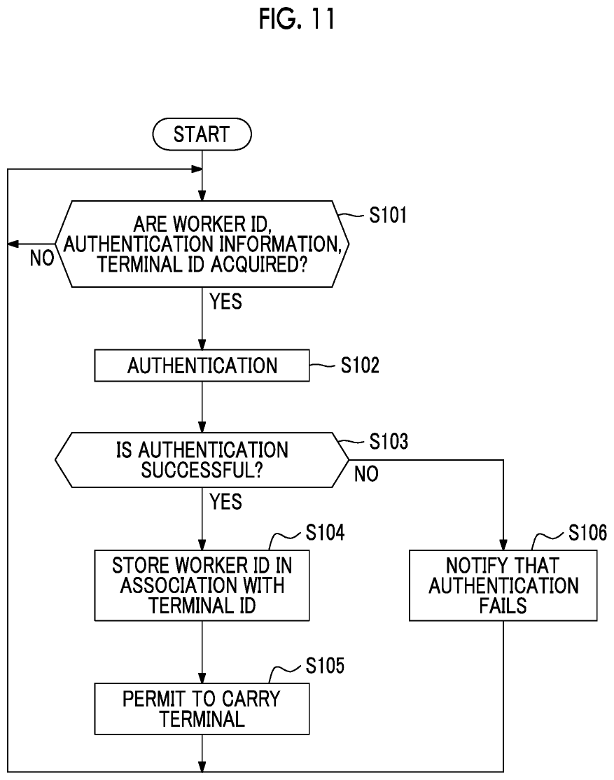

FIG. 11 is a flowchart showing an example of a flow of an operation of the authentication processing. The authentication processing is processing of authenticating the worker and associating the worker with the terminal 2 which is carried.

The processor 11 of the information processing apparatus 1 determines whether or not the worker ID, the authentication information, and the terminal ID are acquired (step S101), and continues the determination during a period which is determined that the pieces of information are not acquired (step S101; NO).

In a case where the processor 11 determines that the worker ID, the authentication information, and the terminal ID are acquired (step S101; YES), the processor 11 collates a set of the acquired worker ID and the authentication information with content of the worker DB 121 and performs authentication on the worker indicated by the worker ID (step S102).

The processor 11 determines whether or not the above-described authentication is successful (step S103). In a case where the processor 11 determines that the authentication is successful (step S103; YES), the processor 11 stores the acquired worker ID in the terminal information DB 122 in association with the terminal ID (step S104), and permits the worker to carry the terminal 2 (step S105). The permission is realized, for example, in such a way that the processor 11 sends a control signal to the terminal 2 worn by the worker and operates the terminal 2. In addition, the processor 11 may send the control signal to a gate at an entrance of the factory and may cause the successfully authenticated worker to enter the factory.

On the other hand, in a case of determining that the authentication fails (step S103; NO), the processor 11 notifies that the authentication fails to the worker indicated by the above-described worker ID (step S106). The notification is performed, for example, by an information presenting machine provided in the display unit 25 of the terminal 2 selected by the worker, the above-described reception terminal device, the gate monitoring device, or the like.

Operation of Notification Processing in Normal Case

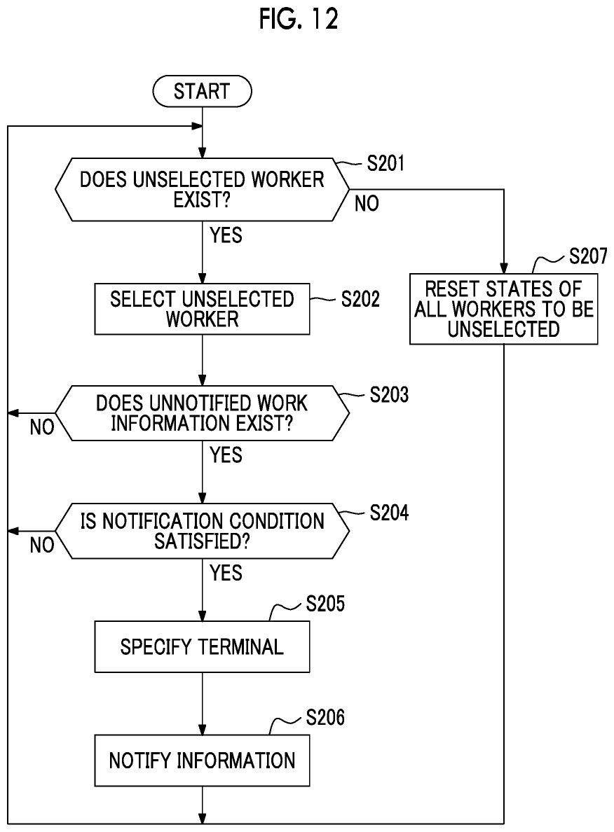

FIG. 12 is a flowchart showing an example of a flow of an operation of the notification processing in the normal case. The notification processing is, for example, a process of scanning the process information DB 124a shown in FIG. 8 and providing a notification to each of the plurality of workers according to the current time. The notification according to the current time is to provide a notification that a start time of a subsequent process is approaching to the worker in a case where the work of the process progresses as scheduled. For example, the notification is sent to the worker, for example, five minutes before a start time of the process in which the worker is in charge.

The processor 11 of the information processing apparatus 1 generates the above-described process information DB 124a from the process information DB 124 stored in the memory 12, and determines whether or not an unselected worker exists for each worker ID described in the worker list 1243 (step S201). For example, in a case where the process information DB 124a is generated, the processor 11 prepares a table, in which the worker IDs described in the worker list 1243 is associated with existence or non-existence of the selection, in the RAM: of the memory 12, and performs the determination according to the table. In the table, “unselected” is associated with all worker IDs in an initial state, and thus the processor 11 determines that an unselected worker exists in a case where the table is in the initial state.

In a case of determining that the unselected worker exists (step S201; YES), the processor 11 selects one worker from among unselected workers (step S202) and determines whether or not work information, which is not notified to the selected worker, exists (step S203). For example, the processor 11 specifies the schedule table 1244 associated with the selected worker ID from the process information DB 124a, refers to the “notification is required” field to determine whether or not the work information, which is not notified to the worker indicated by the worker ID, exists.

In a case of determining that the work information which is not notified does not exist (step S203; NO), the processor 11 returns the process to step S201. In a case of determining that the work information which is not notified exists (step S203; YES), the processor 11 determines whether or not the work information which is not notified satisfies a notification condition according to current time (step S204).

For example, the schedule table 1244 corresponding to the worker ID “U04” shown in FIG. 8 is prepared at a point of time 9:00. At this time, the “notification is required” field corresponding to each of the process IDs “j33” and “J43” is “YES”. The “notification is required” field indicates that the work information which is not notified exists in the processes indicated by the process IDs “j33” and “J43”. However, the work information which is not notified is a so-called reminder that is notified in a case where a time until the start time of the process becomes equal to or less than a determined time, and thus the notification condition is not satisfied at a current time 9:00. On the other hand, for example, after 9:55, a condition for a notification of the reminder indicated by the process ID “j33” is satisfied.

In a case of determining that the notification condition is not satisfied (step S204; NO), the processor 11 returns the process to step S201. In a case of determining that the notification condition is satisfied (step S204; YES), the processor 11 refers to the terminal information DB 122 to specify the terminal 2 carried by the worker identified by the worker ID (step S205), and sends the notification of the above-described reminder to the terminal 2 (step S206).

On the other hand, in a case of determining that unselected worker does not exist in step S201 (step S201; NO), the processor 11 resets states of all the worker IDs to be unselected in the table prepared in the above-described RAM or the like (step S207), and returns the process to step S201.

Notification Processing in Case where Device is Abnormal

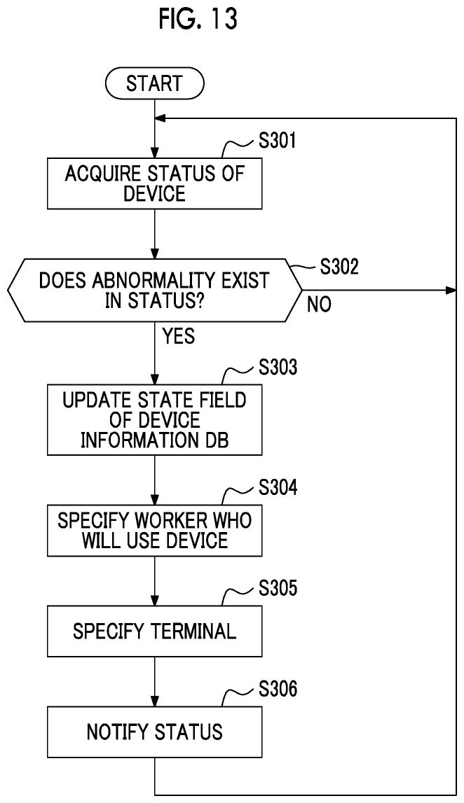

FIG. 13 is a flowchart showing an example of a flow of an operation of the notification processing in a case where the device is abnormal. The notification processing is to provide a notification, in a case where an abnormality is found in the status of the device, to a worker who uses the device currently or in the future.

As described above, the status of the device 4 is detected by the device 4 itself or the terminal 2 that images the device 4, and is transmitted to the information processing apparatus 1. The processor 11 acquires the status of the device 4 via the interface 13 (step S301).

The processor 11 refers to the process information DB 124 to determine whether or not the acquired status of the device 4 is abnormal (step S302). In a case of determining that there is no abnormality (step S302; NO), the processor 11 returns the process to step S301. In a case of determining that there is an abnormality (step S302; YES), the processor 11 updates a field indicating the state of the device 4 in the device information DB according to the acquired status (step S303).

The processor 11 refers to the process information DB 124 to specify the worker who uses the device 4 whose status is determined to be abnormal (step S304). Further, the processor 11 specifies the terminal 2 carried by the specified worker by referring to the terminal information DB 122 (step S305), and notifies the status to the terminal 2 (step S306).

Notification Processing in Case where Unscheduled Work is Detected

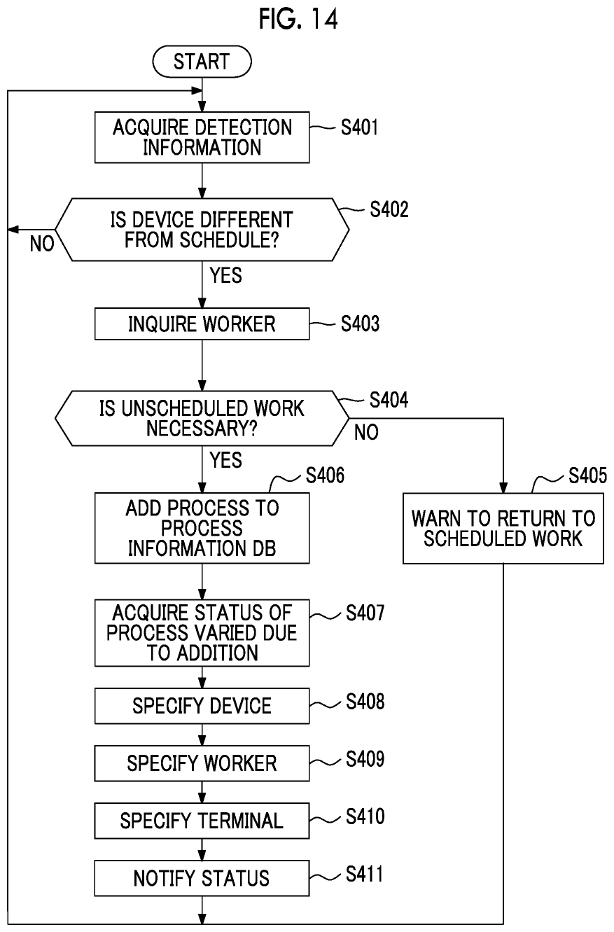

FIG. 14 is a flowchart showing an example of a flow of an operation of the notification processing in a case where the unscheduled work is detected. The notification processing is, in a case where the unscheduled work, that is, a work different from a schedule is detected, to notify information on the work to a relevant worker.

The processor 11 acquires detection information obtained in such a way that any one of the terminal 2 and the device 4 detects the other (step S401), and determines whether or not the device 4 in the vicinity of the terminal 2 is different from the schedule shown in the process information DB 124 (step S402). In a case of determining that the device 4 is not different from the schedule, that is, the device 4 is as scheduled (step S402; NO), the processor 11 returns the process to step S401. In a case of determining that the device 4 is different from the schedule (step S402; YES), the processor 11 inquires the worker who carries (wears) the device 4 as to whether or not an unscheduled work using the above-described device 4 which is not unscheduled is necessary via the terminal 2 in the vicinity of the device 4 (step S403).

The processor 11 determines whether or not the unscheduled work is necessary based on an answer with respect to the above-described inquiry (step S404). In a case of determining that the unscheduled work is not necessary (step S404; NO), the processor 11 warns the worker to return to a work which is scheduled (referred to as a scheduled work) (step S405), and returns the process to step S401.

In a case of determining that the unscheduled work is necessary (step S404; YES), the processor 11 adds a new process indicating the unscheduled work to the process information DB 124 (step S406), and acquires a status of the process which is varied due to addition of the new process (step S407).

In a case where the status of the process that is varied due to the addition of the new process is acquired, the processor 11 refers to the process information DB 124 to specify the device 4 used in the process in which the status is acquired (step S408), and specifies a worker who will use the device 4 currently or in the future (step S409).

Further, the processor 11 refers to the terminal information DB 122 to specify the terminal 2 carried by the specified worker (step S410), and notifies the status of the acquired process to the specified terminal 2 (step S411).

Operational Example in Case where Unscheduled Work is Detected

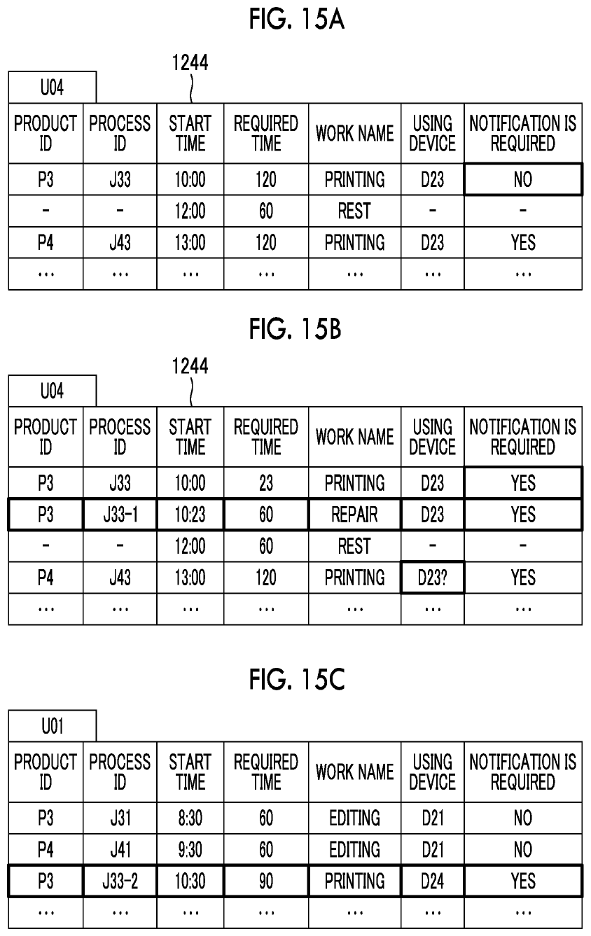

FIGS. 15A to 15C are diagrams showing examples of transition of the schedule table 1244 in a case where the unscheduled work is detected. For example, in a case where the schedule table 1244 corresponding to the worker ID “U04” shown in FIG. 8 notifies the above-described reminder five minutes before the start time of the process indicated by the process ID “J33”, the “notification is required” field associated with the notification is rewritten to “NO”, as shown in FIG. 15A. As a result, a fact that notification of the reminder indicated by the process ID “J33” is completed is shown.

It is assumed that the device 4 which is indicated by the device ID “D23” and is the printing machine fails due to a paper jam or the like at 10:23. At this time, for example, the worker who uses the device 4 and is indicated by the worker ID “U04” opens a cover of a maintenance box of the device 4 and checks the failure. At that time, the imaging unit 26 of the terminal 2 reads the encoded image M attached in the maintenance box, and sends a status indicating a state in which the cover of the maintenance box of the device 4 is open to the information processing apparatus 1. In addition, the device 4 may detect that the cover is open using an open/close detector provided on the cover of the maintenance box, and may send the above-described status to the information processing apparatus 1.

The processor 11 of the information processing apparatus that acquires the status determines that the process indicated by the process ID “J33” cannot be continued due to the failure of the device 4 indicated by the device ID “D23”, and stops the process. Further, the processor 11 generates a process for compensating for the stopped process according to a predetermined procedure, and performs an update of adding the generated process to the process information DB 124.

FIG. 15B shows the schedule table 1244 in which the process indicated by the process ID “J33” is stopped at 10:23 and a new process of repairing the device 4 indicated by the device ID “D23” is added. A process ID “J33-1” is a process of repairing the device 4, which fails in the above-described process and is indicated by the device ID “D23”, and setting is performed such that the start time is 10:23 and the required time is 60 minutes.

In addition, in the schedule table 1244 shown in FIG. 15B, the “using device” field corresponding to the process ID “J43” is rewritten by “D23?”. Since there is no guarantee that the above-described repair is finished in 60 minutes, “D23?” indicates that whether or not the device 4 indicated by the device ID “D23” can be used at 13:00, which is the start time of the process indicated by the process ID “J43”, is unclear.

In addition, FIG. 15C shows a schedule table 1244 of the worker indicated by the worker ID “U01”. The processor 11 acquires the status, recognizes the failure of the above-described device 4, and refers to the device information DB 123 to check whether or not a device 4 for replacing the failed device 4 exists.

In the device information DB 123 shown in FIG. 5, there are two devices 4 that are printing machines, and the device 4 that can replace the failed device 4 indicated by the device ID “D23” is the device 4 indicated by the device ID “D24”. However, in the example of FIG. 5, “failure” is described in the “state” field corresponding to the device ID “D24”, and thus, in this case, the processor 11 determines that there is no replaceable device 4.

In addition, for example, even though the device 4 indicated by the above-described device ID “D24” does not fail, in a case where the condition of the process indicated by the process ID “J33” is described with a fact that a printing machine having a model number which is equal to or higher than Y3 is required, the device 4 is not replaceable. The reason for this is that there is no description in the “model number” field corresponding to the device ID “D24” in the example of FIG. 5.

In a case where the device 4 indicated by the device ID “D24” does not fail and content which limits the printing machine is not described in the process condition of the process ID “J33”, the processor 11 prepares a process of using the device 4 by replacing the failed device 4. At this time, the worker indicated by the worker ID “U04” repairs the failed device 4 indicated by the device ID “D23” using the added process ID “J33-1”.

Therefore, the processor 11 refers to the worker DB 121 and the process information DB 124 to search for a worker who can perform a remaining work of the stopped process “J33” using the device 4 indicated by the device ID “D24” instead of the worker indicated by the worker ID “U04”. For example, in a case where the condition of the process “J33” describes that the worker having the qualification “L4” should do the work, the processor 11 searches for the worker who has the qualification “L4” and is not engaged with another work.

At the point of time 10:23, all of the workers indicated by worker IDs “U05”, “U06”, and “U07” do not perform another work. However, the workers do not have the qualification “L4”. On the other hand, the worker indicated by the worker ID “U01” still works in the process indicated by the process ID “43” at the point of time 10:23, but has the qualification “L4”. Therefore, the processor 11 prepares a new process identified by the process ID “J33-2” whose start time is a time in which the worker finishes the above-described work, and adds the new process to the schedule table 1244 of the worker.

As a result, as shown in FIG. 15C, the process information of the process indicated by the process ID “J33-2” is added to the schedule table 1244 of the worker indicated by the worker ID “U01”. The start time of the added process is set to “10:30”. The start time is time obtained after the required time “60 (minutes)” elapses from the start time “9:30” of the process indicated by the process ID “J41”. Therefore, as soon as the worker indicated by the worker ID “U01” finishes the work in the process indicated by the process ID “J41”, the worker performs the remaining work of stopped process “J33” using the device 4 indicated by the device ID “D24”.

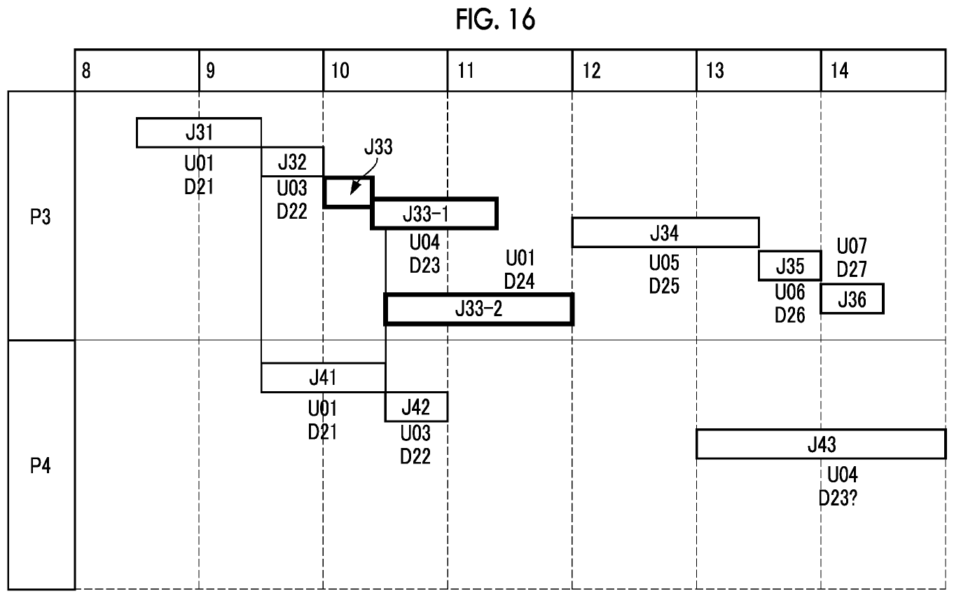

FIG. 16 is a diagram showing an example of the process management table changed by adding the process. The status of the processes, such as a fact that the process indicated by the process ID “J33” is stopped, a fact that the worker repairs the device 4 indicated by the device ID “D23” in a new process indicated by a new process ID “J33-1” from 10:23, or a fact that there is a possibility that the device 4 used in the process indicated by the process ID “J43” is changed, is notified to the worker indicated by the worker ID “U04” from the information processing apparatus 1. As a result, as shown in FIG. 16, the process indicated by the process ID “J33” is stopped, and the worker indicated by the worker ID “U04” who performs the work in the process repairs the failed device 4 indicated by the device ID “D23” in the newly added process indicated by the process ID “J33-1”.

That is, the processor 11 of the information processing apparatus 1 is an example of a processor that specifies the worker who uses the device related to the acquired status currently or in the future by using the schedule information, and provides a notification of the acquired status to the terminal associated with the specified worker in the terminal information DB 122.

On the other hand, a status is notified to the worker indicated by the worker ID “U01” from the information processing apparatus 1, the status indicating that the worker performs a remaining work of the stopped process indicated by the process ID “J33” using the device 4 indicated by the device ID “D24” from 10:30 in the process indicated by the new process ID “J33-2”. As a result, as shown in FIG. 16, the worker indicated by the worker ID “U01” performs the remaining work of the stopped process indicated by the process ID “J33” using the device 4 indicated by the device ID “D24”, instead of the failed device 4 indicated by the device ID “D23” from 10:30 at which the worker finishes the process indicated by the process ID “J41”.

The process indicated by the new process ID “J33-2” is a process that is varied because the process indicated by the process ID “J33-1” is added due to the unscheduled work, and is a process indicated by updated process information. Therefore, the information processing apparatus 1 acquires a status of the process indicated by the process ID “J33-2”. Further, the device related to the status, that is, the device 4 indicated by the device ID “D24” is the worker indicated by the worker ID “U01” who performs the work in the process indicated by the process ID “J33-2”. Therefore, the information processing apparatus 1 notifies the acquired status of the process indicated by the process ID “J33-2” to the worker indicated by the worker ID “U01”. Therefore, the processor 11 is an example of a processor that notifies the status of the process to the worker in the process indicated by the updated process information.

On the other hand, the worker indicated by the worker ID “U02” does not repair the device 4 indicated by the device ID “D23”, and does not continue the work in the stopped process using the device 4 indicated by the device ID “D24”. Therefore, the processor 11 of the information processing apparatus 1 does not notify the above-described status to the worker.

In addition, the workers indicated by the worker IDs “U05”, “U06”, and “U07” do not use any of the devices 4 indicated by the device IDs “D23” and “D24” currently or in the future. Therefore, the processor 11 does not notify the above-described status to the workers. That is, the processor 11 is an example of a processor that does not notify the status to the workers who do not use the device related to the acquired status currently or in the future and the associated terminal in the terminal information.

However, in a case where the process indicated by the process ID “J33-2” is prolonged and is not completed at 12:00, the process indicated by the process ID “J34” is not started because the printed matter processed by the processing machine is not completed. In this case, for example, the device 4 indicated by the device ID “D25” used by the worker indicated by the worker ID “U05” is also included in the device related to the acquired status, and the status is notified to the worker indicated by the worker ID “U05” via the terminal 2 carried by the worker.

Hereinabove, in a case where the above-described operation is performed, the information processing apparatus of the information processing system 9 notifies the information on the statuses of the plurality of devices 4 or processes, the information on the statuses being generated in the plurality of processes, to only the workers who use the devices related to the statuses via the terminals 2 which are carried. On the other hand, the information processing apparatus 1 does not notify the statuses to the workers who do not use the devices related to the above-described statuses. Therefore, according to the information processing apparatus 1, unnecessary notifications for the workers are suppressed, compared to a case where all pieces of information are notified to all workers.

### Modification Example

The content of the above-described exemplary embodiment may be modified as follows. In addition, the following modification examples may be combined with each other.

<1>

In the above-described exemplary embodiment, the information processing apparatus 1 includes the processor 11 configured with a CPU. However, a control unit that controls the information processing apparatus 1 may have another configuration. For example, the information processing apparatus 1 may include various processors in addition to the CPU.

In the embodiments above, the term “processor” refers to hardware in abroad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

<2>

In the embodiments above, the term “processor 11” is broad enough to encompass one processor 11 or plural processors in collaboration which are located physically apart from each other but may work cooperatively.

For example, any of the operations of the processor 11 may be performed by the processor 21 of the terminal 2. In this case, the information processing system 9 is an example of an information processing system including a terminal that includes a processor, and an information processing apparatus that includes a processor, in which at least one of the processors is configured to acquire process information indicating a plurality of processes of manufacturing a product by a worker using a device, acquire terminal information in which the worker is associated with a terminal carried by the worker in each of the plurality of processes, acquire at least one of a status indicating a state of any of a plurality of the devices or a status indicating a state of any of the plurality of processes, specify the worker who uses a device related to the acquired status by using the process information, and provide a notification of the acquired status to the terminal associated with the specified worker in the terminal information.

In addition, the order of operations of the processor is not limited to one described in the embodiments above, and may be changed.

<3>

In the above-described exemplary embodiment, the processor 11 of the information processing apparatus 1 specifies the worker who uses the device 4 based on the process information acquired from the process information DB 124. However, the worker may be specified using another method. For example, in a case where the terminal 2 images the encoded image M attached to the device 4 and detects the device ID, the processor 11 acquires the device ID indicating the device 4 detected by the terminal 2. Since the terminal 2 is carried by the worker and images the encoded image M in the direction of the line of sight of the worker, the device 4 to which the encoded image M is attached is disposed in front of the eyes of the worker. Therefore, the device ID detected by the terminal 2 is the identification information of the device 4 used by the worker.

Further, in a case where the identification information of the device 4 related to the acquired status is common to the identification information of the device 4 acquired from the terminal 2, the processor 11 may specify the above-described worker carrying the terminal 2 as the worker who uses the device 4, and may notify the status to the terminal 2. That is, the processor 11 is an example of a processor that acquires the identification information of the device to be used by the worker who carries the terminal and is detected by the terminal, and specifies the worker who uses the device in a case where the device related to the status is the device indicated in the identification information.

<4>

In addition, the processor 11 of the information processing apparatus 1 may specify the worker who uses the device 4 by using the detection function of the terminal 2 by the device 4. For example, in a case where the device 4 has the function of near field communication, the device 4 detects the terminal 2 in a range connectable by the near field communication. The information processing apparatus 1 acquires the identification information of the terminal 2 detected by the device 4, may specify the terminal 2 which is in the range connectable to the device 4 by the near field communication, and, as a result, may specify the worker who carries the terminal 2 as the worker who uses the above-described device 4. As a result, the notification of the acquired status is provided to the worker who carries the terminal 2 via the terminal 2 detected by the device 4 related to the status. That is, the processor 11 is an example of a processor that notifies the acquired status to the terminal detected by the device.

<5>

In the above-described exemplary embodiment, the processor 11 of the information processing apparatus 1 notifies the status of the process to the worker in the process indicated by the updated process information. However, all the updated process information may not be evenly notified. For example, the status of the process indicated by the updated process information may be notified in a mode according to a degree of the update. In this case, in a case where the processor 11 may evaluate, for example, the degree of the update such as the number of works added by the update, a total required time for the added works, or the number of workers whose work increases due to the added works. Further, for example, in a case where the evaluated the degree of the update is large, the processor 11 may notify the status in a highlighted mode, compared to a case where the degree is small. That is, the processor 11 is an example of a processor that provides a notification in a mode according to the degree of the update of the process information.

<6>

In the above-described exemplary embodiment, the processor 11 of the information processing apparatus 1 specifies a worker who uses the device 4 related to the acquired status currently or in the future, and notifies the status to the specified worker via the terminal 2 that is carried by the worker. However, a mode of the notification of the status may not be common. For example, the mode of the notification may be changed according to a degree of importance of the product to be manufactured. For example, the degree of the importance may be set by the manager in advance and may be determined based on the number of products, the transaction amount, and the like. That is, the processor 11 is an example of a processor that provides a notification in a mode according to the degree of the importance of the product manufactured by using the device related to the status.

<7>

In the above-described exemplary embodiment, the processor 11 of the information processing apparatus 1 notifies the status to the worker who uses the device 4 related to the acquired status. However, even in a case where there is no worker who uses the device 4, the notification of the status may be provided. In this case, the processor 11 may provide the notification to all the workers. However, in order to distinguish from the notification provided in a case where the worker uses the device 4, for example, the notification is provided in a different mode from the case where there is the worker who uses the device 4 related to the status. That is, the processor 11 is an example of a processor that provides the notification to all the workers in a mode different from the case where the worker exists in a case where there is no worker who uses the device related to the acquired status.

<8>

In the above-described exemplary embodiment, the processor 11 of the information processing apparatus 1 notifies the status to the worker who uses the device 4 related to the acquired status. However, in a case where there are a plurality of workers who use the device 4, a fact that there is another worker who uses the device 4 may be notified to each of the workers. The worker who receives the notification in this manner is prevented from thinking that the device 4 can be used only by the worker. That is, this processor 11 is an example of a processor that, in a case where the plurality of workers use the device related to the status, notifies that there is another worker who uses the device to each of the plurality of workers.

<9>

In the above-described exemplary embodiment, the program executed by the processor 11 of the information processing apparatus 1 is an example of a program causing a computer having a processor to perform a process, the process including acquiring process information indicating a plurality of processes of manufacturing a product by a worker using a device, acquiring terminal information in which the worker in each of the plurality of processes is associated with a terminal carried by the worker, acquiring at least one of a status indicating a state of any of a plurality of the devices or a status indicating a state of any of the plurality of processes, specifying the worker who uses a device related to the acquired status by using the process information, and providing a notification of the acquired status to the terminal associated with the specified worker in the terminal information.

The programs may be provided in a state of being stored in a computer-readable recording medium including a magnetic recording medium, such as a magnetic tape and a magnetic disk, an optical recording medium such as an optical disk, a magneto-optical recording medium, a semiconductor memory, and the like. In addition, the program may be downloaded via the communication line such as the Internet.

<10>

In the above-described exemplary embodiment, the terminal 2 included in the information processing system 9 includes a function of allowing the worker to experience so-called mixed reality or augmented reality by using the transmission-type display. However, the terminal 2 may not include the transmission-type display. In this case, the terminal 2 may generate, for example, all images/videos to be shown to the worker. In this case, the worker experiences what is called virtual reality (VR).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to
acquire process information indicating a plurality of processes of manufacturing a product by a worker using a device,
acquire terminal information in which the worker in each of the plurality of processes is associated with a terminal carried by the worker,
acquire at least one of a status indicating a state of any of a plurality of the devices or a status indicating a state of any of the plurality of processes,
specify the worker who uses a device related to the acquired status by using the process information, and
provide a notification of the acquired status to the terminal associated with the specified worker in the terminal information.

2. The information processing apparatus according to claim 1,
wherein the process information includes schedule information indicating a schedule of any of the plurality of processes in which the worker performs work, and
wherein the processor is configured to specify the worker who uses the device related to the status currently or in the future by using the schedule information.

3. The information processing apparatus according to claim 2,
wherein the processor is configured to not provide the notification to the terminal associated in the terminal information with a worker who does not use the device related to the status currently or in the future.

4. The information processing apparatus according to claim 1,
wherein the processor is configured to
acquire identification information of the device which is detected by the terminal and is used by the worker who carries the terminal, and
specify the worker who uses the device in a case where the device related to the status is the device indicated in the identification information.

5. The information processing apparatus according to claim 1,
wherein the processor is configured to acquire the status of the device via a network in a case where the device is connected to the information processing apparatus via the network.

6. The information processing apparatus according to claim 2,
wherein the processor is configured to acquire the status of the device via a network in a case where the device is connected to the information processing apparatus via the network.

7. The information processing apparatus according to claim 3,
wherein the processor is configured to acquire the status of the device via a network in a case where the device is connected to the information processing apparatus via the network.

8. The information processing apparatus according to claim 4,
wherein the processor is configured to acquire the status of the device via a network in a case where the device is connected to the information processing apparatus via the network.

9. The information processing apparatus according to claim 5,
wherein the processor is configured to provide a notification of the acquired status to a terminal detected by the device.

10. The information processing apparatus according to claim 6,
wherein the processor is configured to provide a notification of the acquired status to a terminal detected by the device.

11. The information processing apparatus according to claim 7,
wherein the processor is configured to provide a notification of the acquired status to a terminal detected by the device.

12. The information processing apparatus according to claim 1,
wherein the processor is configured to update the process information indicating the process in which the device is used according to a change in the device related to the acquired status.

13. The information processing apparatus according to claim 12,
wherein the processor is configured to provide a notification of the status of the process to the worker in the process indicated by the updated process information.

14. The information processing apparatus according to claim 12,
wherein the processor is configured to provide the notification in a mode according to a degree of the update of the process information.

15. The information processing apparatus according to claim 1,
wherein the processor is configured to provide the notification in a mode according to a degree of importance of the product manufactured by using the device related to the status.

16. The information processing apparatus according to claim 1,
wherein the processor is configured to, in a case where there is no worker who uses the device related to the acquired status, provide the notification to all workers in a mode different from a case where the worker exists.

17. The information processing apparatus according to claim 1,
wherein the processor is configured to, in a case where a plurality of workers use the device related to the status, provide a notification that there is another worker who uses the device to each of the plurality of workers.

18. The information processing apparatus according to claim 1,
wherein the terminal is a wearable terminal which is worn on a head of the worker.

19. An information processing system comprising:
a terminal that includes a processor; and
an information processing apparatus that includes a processor,
wherein at least one of the processors is configured to
acquire process information indicating a plurality of processes of manufacturing a product by a worker using a device,
acquire terminal information in which the worker in each of the plurality of processes is associated with a terminal carried by the worker,
acquire at least one of a status indicating a state of any of a plurality of the devices or a status indicating a state of any of the plurality of processes,
specify the worker who uses a device related to the acquired status by using the process information, and
provide a notification of the acquired status to the terminal associated with the specified worker in the terminal information.

20. A non-transitory computer readable medium storing a program causing a computer having a processor to execute a process, the process comprising:
acquiring process information indicating a plurality of processes of manufacturing a product by a worker using a device, acquiring terminal information in which the worker in each of the plurality of processes is associated with a terminal carried by the worker,
acquiring at least one of a status indicating a state of any of a plurality of the devices or a status indicating a state of any of the plurality of processes,
specifying the worker who uses a device related to the acquired status by using the process information, and
providing a notification of the acquired status to the terminal associated with the specified worker in the terminal information.
